(19) United States
(12) Patent Application Publication
(10) Pub. No.: US 2016/0001917 A1
(43) Pub. Date: Jan. 7, 2016

(54) WEBBED CORNER REVERSE FOLDED PAPERBOARD TRAY

(71) Applicant: Rock-Tenn Shared Services, LLC, Norcross, GA (US)

(72) Inventors: Richard J. Gould, St. Paul, MN (US); David W. Northrup, Johns Creek, GA (US)

(21) Appl. No.: 14/755,909

(22) Filed: Jun. 30, 2015

Related U.S. Application Data
(60) Provisional application No. 62/019,792, filed on Jul. 1, 2014.

(51) Int. Cl. B65D 5/24; B31B 1/26; B65D 5/42

(52) U.S. Cl. CPC B65D 5/244; B65D 5/4266; B31B 1/26

(57) ABSTRACT

Disclosed is a paperboard tray that includes a bottom panel; a plurality of side panels, each side panel attached to an edge of the bottom panel; a plurality of outer panels, each outer panel attached to an outer edge of one of the side panels; and a plurality of corner gussets that connect a pair of adjacent side panels of the plurality of side panels. A first subset of the plurality of corner gussets is adhered to a first of the plurality of side panels and a first of the plurality of outer panels is adhered to the first subset of the plurality of corner gussets. A second subset of the plurality of corner gussets is adhered to a second of the plurality of side panels and a second of the plurality of outer panels is adhered to the second subset of the plurality of corner gussets.

### CROSS REFERENCE TO RELATED APPLICATIONS

The present application claims the benefit of U.S. Provisional Application No. 62/019,792, filed on Jul. 1, 2014, entitled “WEBBED CORNER REVERSE FOLDED PAPERBOARD TRAY,” which is hereby incorporated by reference in its entirety.

### TECHNICAL FIELD

Embodiments of the present invention relate to folded paperboard trays.

### BACKGROUND

Webbed cornered leak resistant trays constructed from a cut, scored, and folded blank are convenient for storing and transporting food, for example, but not limited to, the transportation and storage of food with liquid properties. Some known trays are constructed of expanded polystyrene which, when shipped to the customer, require a lot of shipping space since the trays do not have a knocked down flat construction but instead are of a molded shape. It is desirable to have a leak resistant tray that can be shipped flat and formed at the customer's location to decrease shipping space (and thus costs) required for transporting the leak resistant tray to the customer. For example, but without limitation, a webbed corner folded leak resistant tray may contain fresh meat or other food or non-food products. The tray may then be shrink wrapped for storage or transportation of the food item.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this application, and any or all drawings or figures.

Disclosed is a webbed corner folded leak resistant tray formed from a single blank that is capable of being folded and glued on standard machinery. The flat carton blank of foldable material may have two pairs of opposing side panels hingedly connected by gussets as well as two opposing pairs of outer panels. The tray may be folded and sealed so that no cut or exposed edges are in contact with the product contained inside the tray. In some embodiments, the blank may be made of a paper stock having a one or two side clear or pigmented polymer such as polyethylene or polypropylene extrusion coating, with an internal sized water-resistant fiber cellulose paper between the two polymer layers. In other embodiments, the blank may be made of a two-sided low-density polyethylene (“LDPE”) coated carton (such a milk carton), a two-sided LDPE coated cup stock, or a two-sided LDPE coated canister grade of paperboard, or any other suitable material.

### BRIEF DESCRIPTION OF THE DRAWINGS

FIG. 1 is a plan view of a unitary blank of a foldable material that may be folded and glued to form a paperboard tray.

FIGS. 2A and 2B are perspective views of a paperboard tray partially erected from the blank of FIG. 1.

FIG. 3 is a perspective top view of the erected paperboard tray of FIG. 2.

FIG. 4 is a partial perspective view of the erected paperboard tray of FIG. 2.

FIG. 5 is a perspective view of the erected paperboard tray of FIG. 2 including a food article in the tray receptacle and shrink wrapped.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

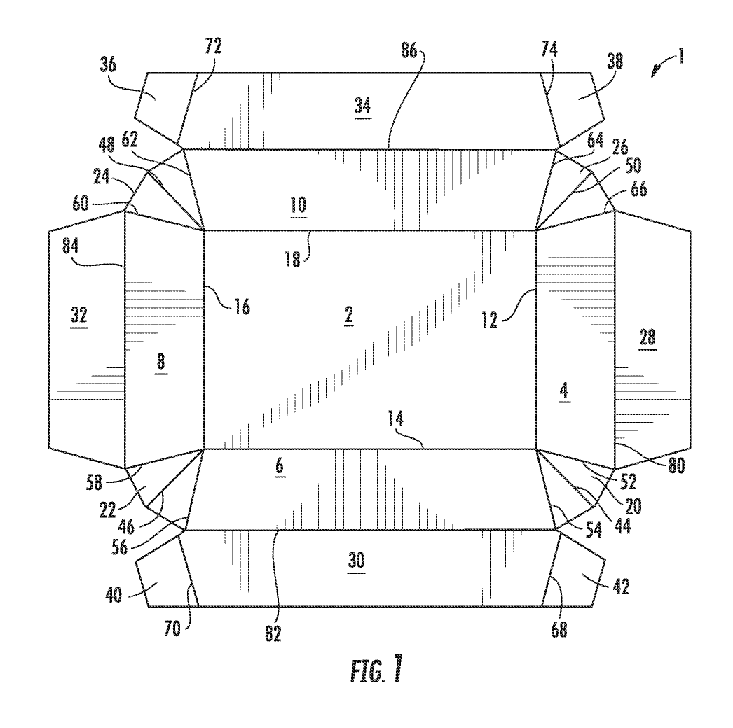

Referring now to the drawings for a better understanding of the invention, FIG. 1 illustrates a single blank of foldable material. The foldable material may be paper-based material such as paperboard, although other materials may be used if desired. In embodiments using paperboard, the paperboard may be formed from virgin or recycled material, and may be single-ply or laminated paperboard. In some embodiments, the foldable material can be a foldable material having a pigmented or clear polyethylene layer or other water-resistant polymer application, or can be an internal high sized water-resistant milk carton stock, two-sided LDPE coated cup stock, or two-sided LDPE coated canister grades of paperboard, though other suitable foldable materials may be used. The foldable material can be coated to aid in reducing the absorption of liquids by the foldable material. In some embodiments, the foldable material can be coated with a polyethylene extrusion or alternative extrudable biodegradable, compostable polymers such as polylactic acid (“PLA”) or water based high holdout polymer emulsions, though other suitable coatings may be used.

As illustrated, blank 1 includes a bottom panel 2 that is generally rectangular in shape, though it may be any other suitable shape and have any desired dimensions. For example, the bottom panel 2 may be circular, triangular, square, pentagonal, hexagonal, heptagonal, octagonal, etc. (with the appropriate shape and number of side panels based on the shape of the bottom panel 2). Blank 1 includes side panels 4, 6, 8, 10 that are foldably connected to the respective edges of bottom panel 2 at fold lines 12, 14, 16, 18, respectively. Side panels 4 and 6 are hingedly connected to one another via foldable gusset 20. Similarly, side panels 6 and 8 are hingedly connected to one another via foldable gusset 22, while side panels 8 and 10 are hingedly connected to one another via foldable gusset 24, and side panels 10 and 4 are hingedly connected to one another via foldable gusset 26. Outer panels 28, 30, 32, 34 are foldably connected to the respective side panels 4, 6, 8, 10 at fold lines 80, 82, 84, 86, respectively. Outer panel 34 includes a tab 36 foldably connected to a left edge of outer panel 34 at fold line 72. Outer panel 34 also includes a tab 38 foldably connected to a right edge of outer panel 34 at fold line 74. Similarly, outer panel 30 includes a tab 40 foldably connected to a left edge of outer panel 30 at fold line 70. Outer panel 30 also include a tab 42 foldably connected to a right edge of outer panel 30 at fold line 68.

As shown in FIG. 1, the bottom panel 2 includes two long edges (fold lines 14 and 18) and two short edges (fold lines 12 and 16).

Each gusset 20, 22, 24, 26 includes a diagonal center fold line 44, 46, 48, 50, respectively. In addition, each gusset 20, 22, 24, 26 includes two outer fold lines 52 and 54; 56 and 58; 60 and 62; 64 and 66, respectively. As explained in more detail below, each gusset may be folded and glued against an adjacent side panel when the blank is erected.

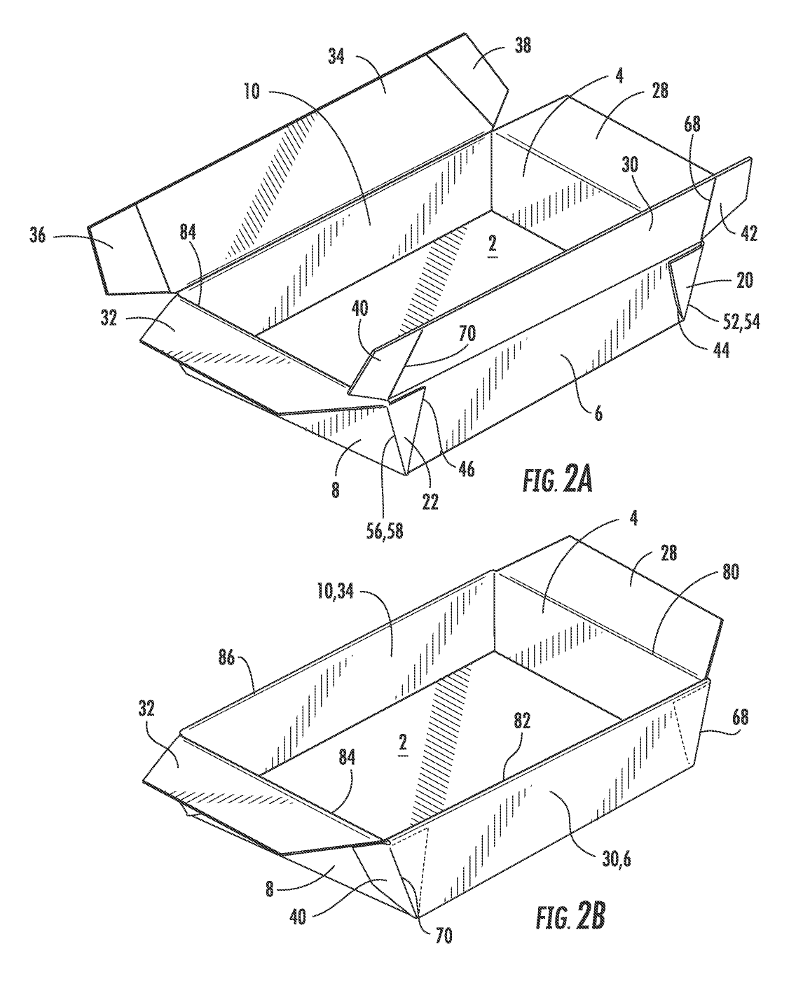

The blank 1 shown in FIG. 1 may be erected into a leak resistance tray. When opposing side panels 4, 8 and 6, 10 are folded substantially upright about their respective fold lines at angle of approximately 65-90 degrees with respect to the bottom panel 2, a tray receptacle or receiving area is formed. With the side panels 4, 6 folded substantially upright about respective fold lines 12, 14, gusset 20 is folded along fold lines 52, 54, 44 such that gusset 20 is folded against the outer surface of side panel 6. As shown in FIG. 2A, gusset 20 is folded into a triangular shape such that fold line 44 is the inner-most edge of the resultant folded gusset 20. Gusset 20 is maintained in this position by applying adhesive between the exterior of side panel 6 and the interior surface of gusset 20 where gusset 20 is folded back against side panel 6. Similarly, gusset 22 is folded and maintained in place against side panel 6 via fold lines 56, 58, 46 such that fold line 46 is the inner-most edge of the triangular resultant shape of gusset 22 (see FIG. 2A). Gusset 24 is folded and adhered in place against side panel 10 via fold lines 60, 62, 48; and finally gusset 26 is folded and adhered in place against side panel 10 via fold lines 64, 66, 50. The adherence of gussets 20, 22, 24, 26 against opposing side panels 6, 10 may be completed by standard folding and gluing machines if desired. In other embodiments, gussets 20, 22, 24, 26 could be folded and secured against the other adjacent side panel (i.e., side panels 4 and 8).

As shown in FIG. 2B, with the side panels 4, 6, 8, 10 and gussets 20, 22, 24, 26 folded and glued in place, outer panels 30, 34 may be folded downwards against the outer surface of the side panels from which they respectively extend. In particular, outer panel 30 is folded down and glued against the outer surface of side panel 6 and folded gussets 20, 22 with tabs 40, 42 extending outwards. Tab 42 is folded along fold line 68 and adhered in place against the outer surface of side panel 4. Tab 40 is folded along fold line 70 and adhered in place against the outer surface of side panel 8. As shown in FIG. 2B, once outer panel 30 is folded and attached to side panel 6, fold line 82 is disposed as the upper edge of the tray. Similarly, outer panel 34 is folded down and adhered against the outer surface of side panel 10 and folded gussets 24, 26 with tabs 36, 38 extending outwards. Tab 36 is folded along fold line 72 and adhered in place against the outer surface of side panel 8. Tab 38 is folded along fold line 74 and adhered in place against the outer surface of side panel 4.

After outer panels 30 and 34 (and their respective tabs 36, 38, 40, 42) are adhered in position, outer panel 28 is folded against the outer surface of side panel 4 and against tabs 38, 42 and adhered in place. Outer panel 32 is folded against the outer surface of side panel 8 and against tabs 36, 40 and adhered in place. In some embodiments, outer panels 28, 32 may each include an embossing that creates an indentation that receives the tabs 38, 42, 36, 40, respectively. In some embodiments, outer panels 28, 32 may include tabs instead of the tabs 36, 38, 40, 42, in which case the gussets 20, 22, 24, 26 may be folded against side panels 8, 10. The folding and gluing described above can be done by a standard folding and gluing machine if desired.

The blank 1 may be cut from a larger sheet or roll of material coated as described above such that the outer perimeter of the blank 1 (i.e., the cut edges) are the only portion of the blank 1 that is not coated. When the blank 1 is erected in the manner described above, the exposed cut edges of the foldable material, which lack a coating along the cut edge, are positioned on the outer surface of the tray. The exposed cut edges positioned on the outer surface of the tray, away from the receiving area of the tray, prevent contact between the exposed or cut edges and any liquid or food present in the receiving area of the tray. In other words, any liquid or food present within the receiving area of the tray only contacts the coated surfaces of the foldable material. This prevents the absorption of the liquid by the foldable material, which could weaken the tray or cause the liquid to leak out of the tray. By preventing contact between the cut edges of the foldable material and the liquid, food, or other product within the tray, the foldable material may not absorb a liquid within the receiving area of the tray. The layering of the outer panels 28, 30, 32, 34 against the outer surface of the side panels 4, 6, 8, 10 also provides additional structural support to the tray, as do tabs 36, 38, 40, 42 and gussets 20, 22, 24, 26 at each respective corner.

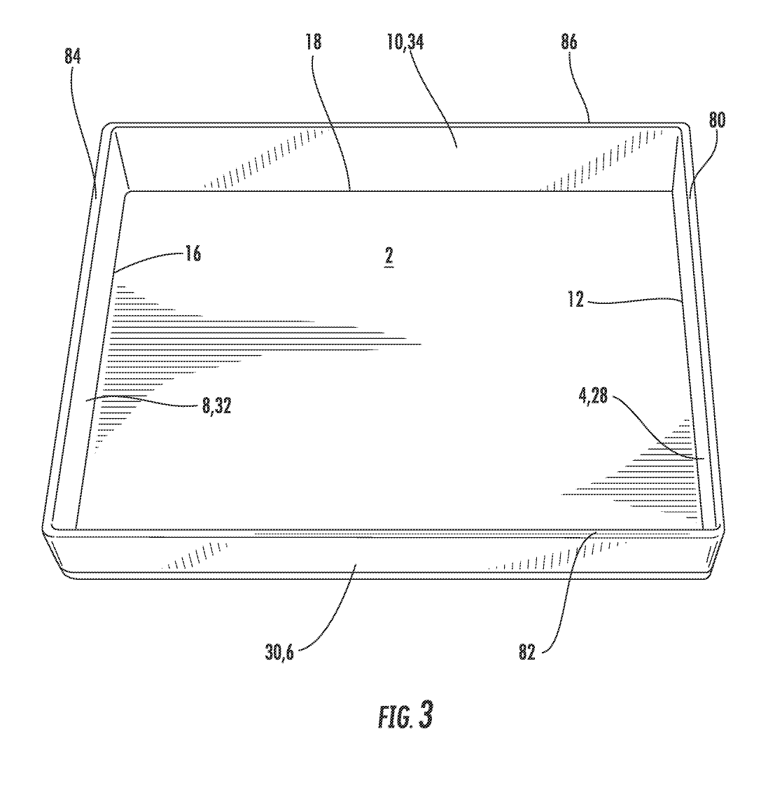

As shown in FIG. 3, each side panel of the fully erected tray spanning between the corners includes two full layers of material. For example, the front panel (as seen in FIG. 3) includes outer panel 30 as the outer surface and side panel 6 disposed interior to the outer panel 30 such that fold line 82 forms the upper edge of the front panel. Similarly, the rear panel (as seen in FIG. 3) includes side panel 10 as the inner-most layer and outer panel 34 as the outer surface such that fold line 86 forms the upper edge of the rear panel. The left and right panels (as seen in FIG. 3) include side panels 8 and 4 as the inner-most layers, respectively, and outer panels 32 and 28 as the outer surfaces, respectively, such that fold lines 84 and 80 form the upper edges of the left and right panels, respectively.

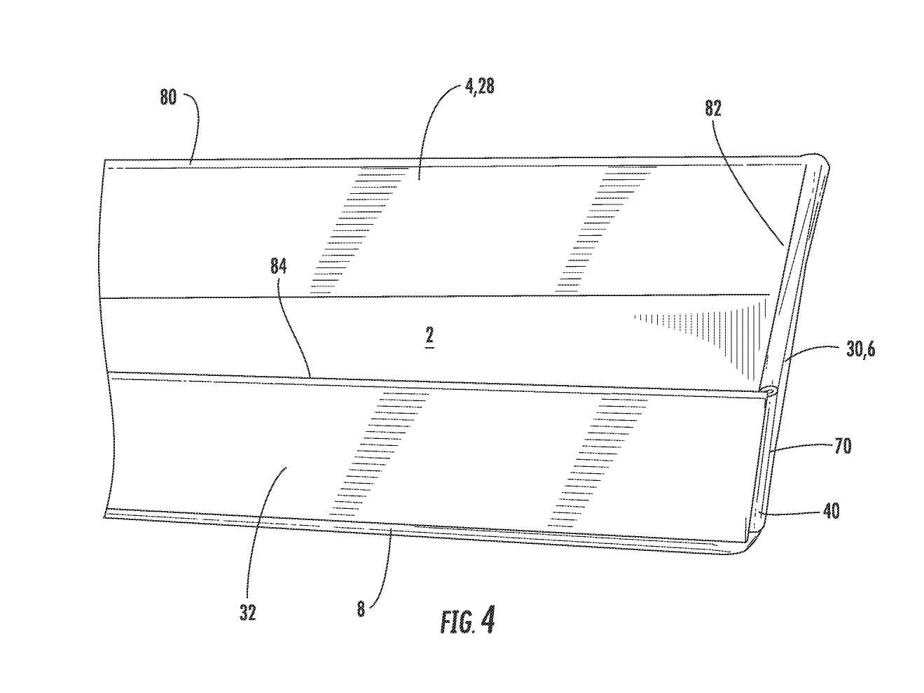

Moreover, based on the folding arrangement described above, each corner includes additional layers of material. For example, foldable gussets 20 and 22, when folded in place as shown in FIG. 2A, each provide two additional layers of material between side panel 6 and outer panel 30. These additional layers of material form an approximately triangular shape. Thus, for each of these triangular areas (shown in hidden lines in FIG. 2B), there is four layers of material. In addition, tabs 36, 38, 40, 42 also provide additional layers of material. For example, as shown in FIG. 2B, tab 40 provides one additional layer of material between outer panel 32 and side panel 8. Tabs 36, 38, 42 similarly provide additional layers of material. FIG. 4 shows a detail view of the fully erected corner where tab 40 is folded about fold line 70 and attached to side panel 8 and outer panel 32 is folded about fold line 84 and attached to tab 40.

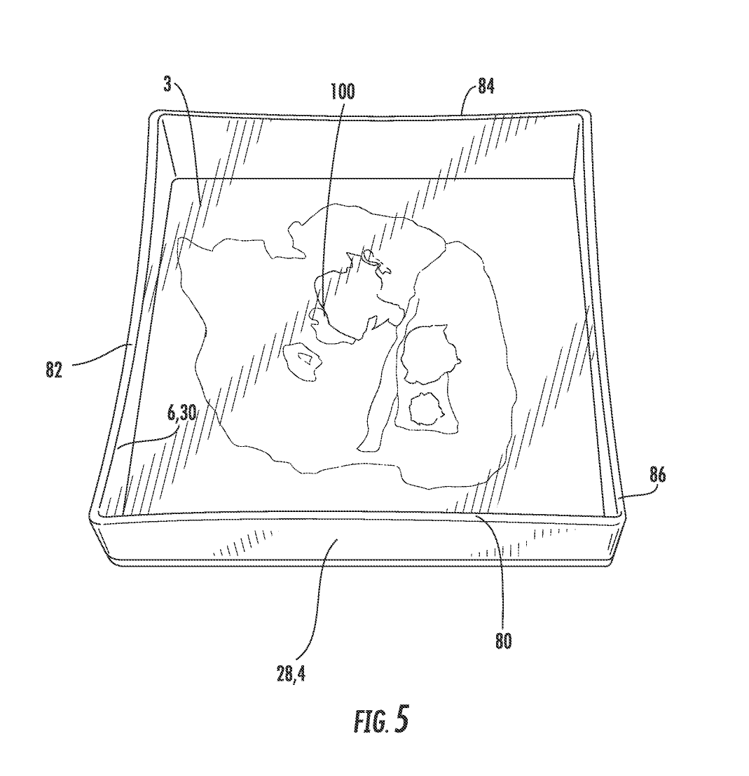

Embodiments of the invention are shown in the erected stage from various views in FIGS. 3-5. After introduction of the food or other product 100 in the receiving area of the tray, shrink wrap 3 or other suitable cover material 3 can be wrapped around the tray to secure the food 100 within the tray for storage or transport (see FIG. 5).

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A paperboard tray comprising:
a bottom panel;
a plurality of side panels, each side panel attached to an edge of the bottom panel;
a plurality of outer panels, each outer panel attached to an outer edge of one of the side panels; and
a plurality of corner gussets, each of the plurality of corner gussets connecting a pair of adjacent side panels of the plurality of side panels, wherein:
a first subset of the plurality of corner gussets is adhered to a first of the plurality of side panels and a first of the plurality of outer panels is adhered to the first subset of the plurality of corner gussets;
a second subset of the plurality of corner gussets is adhered to a second of the plurality of side panels and a second of the plurality of outer panels is adhered to the second subset of the plurality of corner gussets; and
the paperboard tray has a flat configuration and an erected configuration.

2. The paperboard tray of claim 1, wherein, in the erected configuration, each of the plurality of corner gussets is folded about three fold lines.

3. The paperboard tray of claim 1, wherein, in the erected configuration, each of the plurality of corner gussets is folded into an approximately triangular shape and provides two additional layers of material between one of the plurality of side panels and one of the plurality of outer panels.

4. The paperboard tray of claim 1, wherein, in the erected configuration, each of the plurality of outer panels is folded onto one of the plurality of side panels.

5. The paperboard tray of claim 1, wherein, in the erected configuration, the paperboard tray includes upper edges formed from fold lines between each of the plurality of side panels and each of the plurality of outer panels.

6. The paperboard tray of claim 2, wherein:
at least one of the plurality of outer panels includes a foldable tab at each end; and
each tab is folded around a corner of the paperboard tray and adhered to one of the plurality of side panels in the erected configuration.

7. The paperboard tray of claim 1, wherein the bottom panel is rectangular.

8. The paperboard tray of claim 1, wherein:
in the erected configuration, each pair of adjacent side panels forms a corner; and
a first side of the corner includes two additional layers from one of the plurality of corner gussets and a second side of the corner includes one additional layer from a tab of one of the plurality of outer panels.

9. A paperboard blank comprising:
a rectangular bottom panel with two long edges and two short edges;
four side panels, each of the four side panels foldably connected to one of the two long edges or one of the two short edges of the rectangular bottom panel;
four outer panels, each outer panel foldably connected to an outer edge of one of the four side panels, wherein at least two of the four outer panels include a foldable tab at each end of the at least two outer panels; and
four corner gussets connecting the four side panels wherein each of the four corner gussets includes a center fold line and two outer fold lines.

10. The paperboard blank of claim 9, wherein each center fold line bisects the respective corner gusset into two equally sized triangles.

11. The paperboard blank of claim 9, wherein the at least two outer panels are two outer panels corresponding to the two long edges of the rectangular bottom panel.

12. A method of erecting a paperboard tray, the method comprising:
providing a blank with a rectangular bottom panel with two long edges and two short edges; four side panels foldably connected to the edges of the rectangular bottom panel; four outer panels, each outer panel foldably connected to an outer edge of one of the four side panels; and four corner gussets connecting the four side panels, wherein each of the four corner gussets includes a center fold line and two outer fold lines;
folding the four side panels with respect to the rectangular bottom panel;
folding the four corner gussets about the center fold line and the two outer fold lines so that two of the four corner gussets rest against a first of the four side panels corresponding to a first of the two long edges and two of the four corner gussets rest against a second of the four side panels corresponding to a second of the two long edges;
folding two of the four outer panels that correspond to the two long edges of the rectangular bottom panel so that a first of the two outer panels covers the two corner gussets resting against the first of the four side panels and so that a second of the two outer panels covers the two corner gussets resting against the second of the four side panels; and
folding two of the four outer panels that correspond to the two short edges of the rectangular bottom panel.

13. The method of claim 12 further comprising gluing the four corner gussets into position.

14. The method of claim 12 comprising:
folding each of the four corner gussets into a triangular shape.

15. The method of claim 14 comprising:
fastening a surface of the triangular shape to a surface of two of the four side panels that correspond to the two long edges of the rectangular bottom panel.

16. The method of claim 14, wherein the center fold line of each of the four corner gussets forms an inner-most edge of the triangular shape.

17. The method of claim 12, wherein folding two of the four outer panels that correspond to the two long edges of the rectangular bottom panel comprises adhering the two of the four outer panels to at least one of (a) a surface of a corresponding side panel and (b) two corner gussets folded into triangular shapes.

18. The method of claim 12, wherein two of the four outer panels that correspond to the two long edges of the rectangular bottom panel each include tabs at either end, the method further comprising:
folding the tabs onto two of the four outer panels that correspond to the two short edges of the rectangular bottom panel.

19. The method of claim 18, further comprising adhering the tabs into position.

20. The method of claim 12, wherein folding two of the four outer panels that correspond to the two short edges of the rectangular bottom panel comprises adhering the two of the four outer panels to at least one of (a) a surface of a corresponding side panel and (b) two tabs attached to two of the four outer panels that correspond to the two long edges of the rectangular bottom panel.
